(19) United States
(12) Patent Application Publication
(10) Pub. No.: US 2012/0210553 A1
(43) Pub. Date: Aug. 23, 2012

(54) High Capacity Suction Cup and Method

(76) Inventor: Stephen C. Chen, Weston, MA (US)

(21) Appl. No.: 13/029,759

(22) Filed: Feb. 17, 2011

(51) Int. Cl. B23P 17/04; B66C 1/02

(52) U.S. Cl. 29/428; 294/183

(57) ABSTRACT

The embodiment of this invention is a high capacity vacuum suction cup that is very light in weight and can hold up a very heavy load. The light weight construction includes a radial laminated, flexible Kevlar® fabric suction cup reinforced with a rigid outskirt ring. The hoist ring attachment assembly is optimally sized for grabbing the cup but not breaking the cup fabric under minimum weight constraint. The suction cup utilizes a gum material sealer ring to seal vacuum on unsmooth but nonporous surface. The suction cup has a vacuum hose attachment nozzle that allows hooking up of external vacuum hose. A typical high capacity suction cup of this invention weighs about five pounds and can hold up more than 2,500 pounds of load.

This invention was made with government support under (N68335-07-C-0331) awarded by (Naval Air Warfare Center—Aircraft Division). The government has certain rights in the invention.

### BACKGROUND OF THE INVENTION

This invention is derived from a Navy SBIR program for the purpose of autonomously securing aircraft on carrier deck without using deck based pad-eyes. The suction cup approach originated from one of the Phase I feasibility studies contracted to Innovatex Inc. A concept prototype suction cup was developed as the result of this study program. This prototype suction cup weighs less than 5 pounds and can hold up to more than 2,500 pounds of load. This study did not continue into the Phase II development but the prototype may be utilized in other military and commercial applications, such as: fastening mobile equipment on ship deck, using as a ship hall grabbing device of mooring facilities, or lifting heavy steel plates in municipal road construction projects. There are many suction cups patented today, for examples U.S. Pat. Nos. 7,793,899 and 7,338,020, but none of them are capable of lifting tons of load and attaching to an unsmooth surface.

### BRIEF SUMMARY OF THE INVENTION

The present invention relates generally to a vacuum fastening device and method. More particularly, it relates to a lightweight heavy load suction cup that can attach to nonporous surface regardless the smoothness of the surface conditions.

The invention of this High Capacity Suction Cup comprises of (1) a flexible high strength suction cup with rigid outskirt ring, (2) a vacuum sealer ring for adapting the suction cup to an unsmooth surface, (3) a hoist ring attachment assembly, and (4) a vacuum hose attachment nozzle. The total weight of this invented suction cup is less than 5 pounds and can lift more than 2,500 pounds of load.

The uniqueness of this suction cup comprises of its high load-to-cup-weight ratio, unsmooth surface adaptability, and ultra light weight.

To assure lightweight construction, the suction cup is made of vinyl coated, laminated, high strength Kevlar® fabric. The hoist ring attachment assembly is made of lightweight, high strength steel and aircraft aluminum.

The vacuum suction is generated via external vacuum pumping. The vacuum sealer ring will stick on the outskirt of the suction cup but be detachable from the load surface. Intermittent activation of vacuum line is required to compensate possible vacuum leak so that the vacuum within the suction cup is maintained at proper level. The cup can be removed from the load surface by deactivating the vacuum line.

The current invention has many advantages over prior devices that perform similar functions:

1. The disadvantage of prior devices is that none of those devices can hold on an unsmooth surface such as ship deck coated with non-skid paint.

2. This device of this invention is designed to utilize ultra lightweight material while the prior devices are made of heavier molded rubber or plastic.

3. The device of this invention is designed to hold up more than one ton of load while the prior devices were not designed to hold up such heavy load.

### BRIEF DESCRIPTION OF THE SEVERAL VIEWS OF THE DRAWING

FIG. 1 is the 3D sketch of the device of this invention.

FIG. 2 is the side view and top view of the device of this invention.

FIG. 3 is the detailed engineering drawing of the hoist ring attachment assembly.

FIG. 4 is the layout of radial laminated Kevlar® fabric.

### DETAILED DESCRIPTION OF THE INVENTION

The embodiment of this invention is a vacuum suction device that enables the application of a heavy lifting force on a flat non-porous surface regardless of the smoothness of the surface.

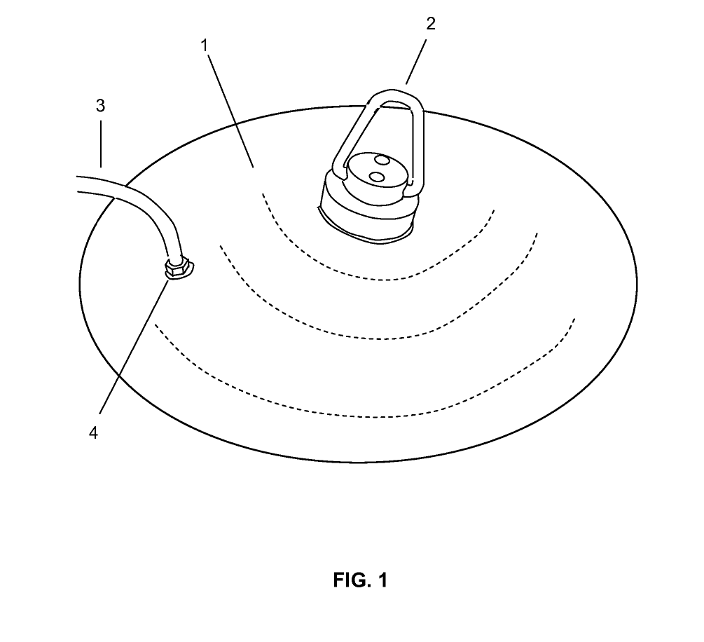

Referring now to FIG. 1, the device of this invention comprises of a vinyl coated, laminated, Kevlar® fabric cup 1, a hoist ring assembly 2, a vacuum suction hose 3, and a vacuum hose attachment nozzle 4.

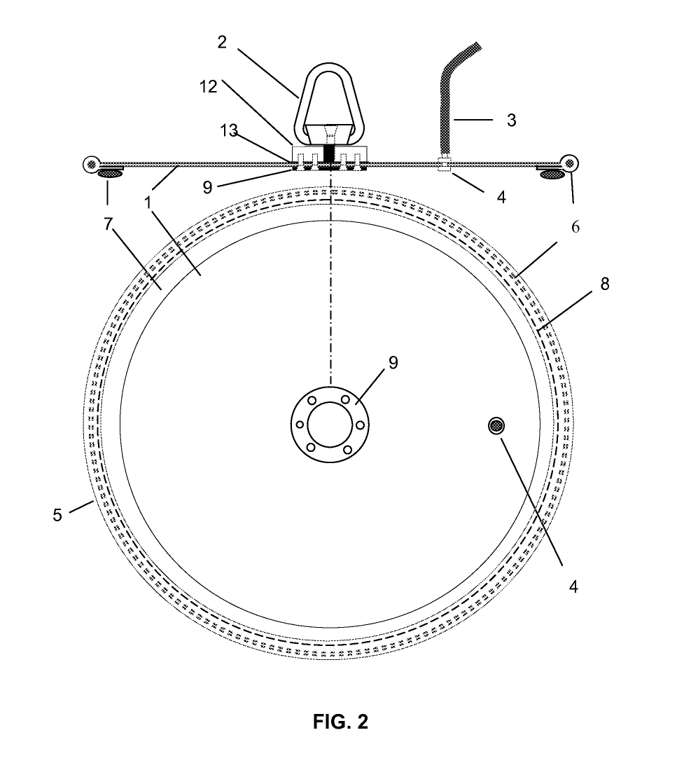

Referring now to FIG. 2, it shows the side and bottom views of the device of this invention. The diameter of this suction cup is approximately 22 inches 5. For the purpose of preventing shrinkage of the flexible fabric cup under lifting load, the outskirt of the suction cup 1 is reinforced with a rigid steel ring 6. The suction cup fabric is wrapped around the steel ring and fastened with stitches 8. The edge of wrapping and stitches are sealed with vinyl resin. Underneath the steel reinforcement ring is a vacuum sealer ring made of gum material 7 which will enable the suction cup to seal on the water moist surface but not stick on the surface permanently. The purpose of using the gum material is to enable the vacuum suction cup to adapt to rough uneven surface. In the side view, hoist ring 2 is mounted on hoist ring base block 12 which is sealed on the suction cup with a rubber gasket 13. In the bottom view, the center of the suction cup is a hoist ring base block mounting plate 9.

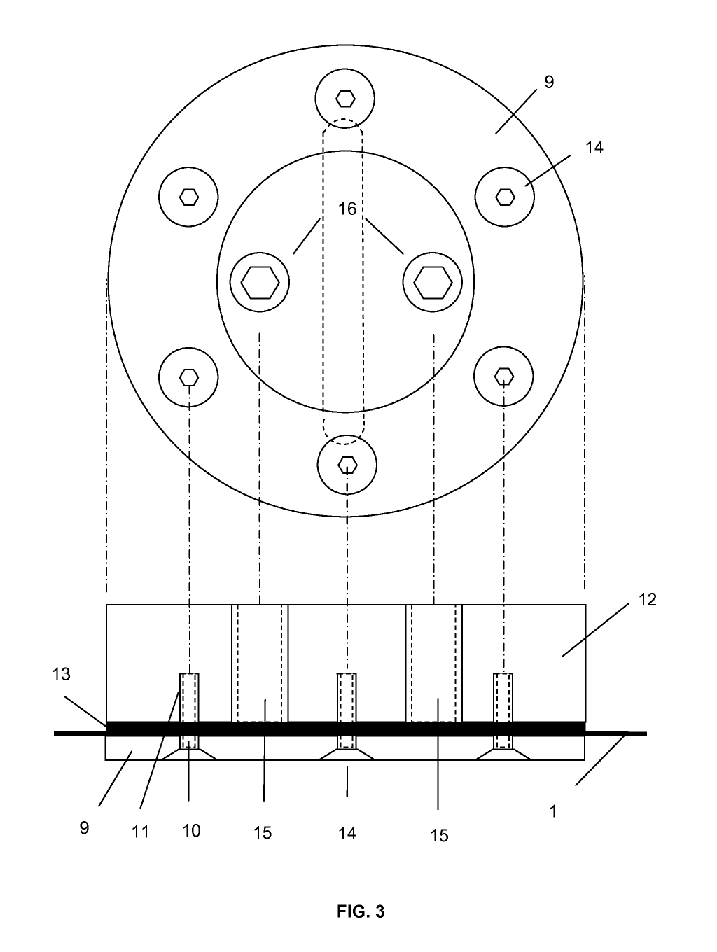

Referring now to FIG. 3, it shows the bottom and side views of the hoist ring attachment assembly. The fabric of suction cup 1 is sandwiched between the hoist ring base block 12 made of high strength aircraft grade aluminum, rubber gasket 13, and base block mounting plate 9. The base block mounting plate has six through holes 10 that match the six threaded non-through holes 11 on the base block. These holes allow mounting of base block mounting plate via screws 14. The center of the base block has two threaded through holes 15 that allow the hoist ring 2 to be mounted on top of the base block with two screws 16.

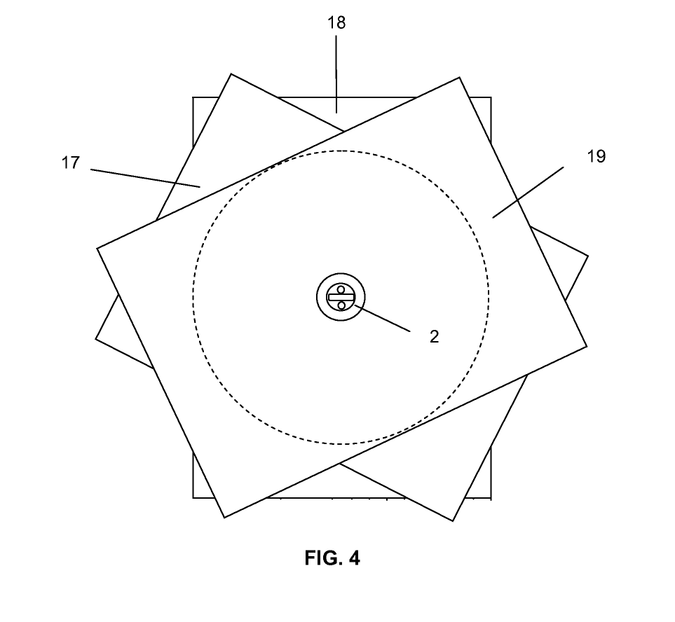

Referring now to FIG. 4, it shows the layout of three layers Kevlar® fabric laminated with vinyl resin. The fabric strength is different in length and width directions. The width direction has higher strength than the length direction and the strength at 45 degree direction between length and width directions is the weakest. To achieve more uniformed stress distribution, the suction cup is constructed with three layers of Kevlar® fabric laminated in three radial directions. The fabric 17, 18, and 19 are positioned 60 degrees apart with the hoist ring assembly 2 as its rotation center.

The method of applying this suction cup is to first moisturize the load surface and then place the suction cup on the surface. The surface must be flat and nonporous. The next step is to apply vacuum suction to the cup through its vacuum hose attachment nozzle. The vacuum is to be maintained via an external vacuum pump which will run, on as needed basis, to maintain proper vacuum pressure. The suction cup is now ready to lift the load. To detach the suction cup from the load surface is done by first removing the external vacuum suction and open the vacuum hose to atmospheric air. The next step is to apply force to lift the suction cup. The suction cup will separate from the load surface. The gum sealing ring will stick on the cup rather than on the load surface because the moisture between the gum and load surface prevents the gum to stick on the load surface.

1. A device, comprising a light weight flexible suction cup with a rigid outskirt ring, a vacuum hose attachment nozzle on the cup, hoist ring attachment assembly, and vacuum sealer ring.

2. The device of claim 1 wherein said vacuum sealer ring is made of gum material capable of adapting to unsmooth but non-porous surface.

3. The device of claim 1 wherein said hoist ring attachment assembly comprises a hoist ring mounted on a base block with two screws. The suction cup fabric is sandwiched between the base block, the rubber gasket, and the base block mounting plate via non-through-hole screws.

4. The device of claim 1 utilizes a radial laminated Kevlar® fabric cup, with the hoist ring attachment position at the center, and the lamination is done via vinyl resin.

5. The method of attaching vacuum suction cup to unsmooth surface.
